(19) United States
(12) Patent Application Publication
(10) Pub. No.: US 2007/0201411 A1
(43) Pub. Date: Aug. 30, 2007

(54) Line of sight determination between nodes of a wireless network

(75) Inventor: Cyrus Behroozi, Menlo Park, CA (US)

Correspondence Address: Tropos Network Patent Dept, PO Box 641867, San Jose, CA, 95164-1867, US

(73) Assignee: Tropos Networks, Inc.

(21) Appl. No.: 11/362,937

(22) Filed: Feb. 27, 2006

(51) Int. Cl. H04Q 7/24

(52) U.S. Cl. 370/338

(57) ABSTRACT

A method and apparatus for determining line of sight between nodes of a wireless network is disclosed. The method includes identifying line-of-sight links between nodes within the wireless mesh network, and communicating the line-of-sight links between nodes to the system operator, allowing the system operator to selectively replace non-line-of-sight technology nodes with higher capacity line-of-sight nodes.

### FIELD OF THE INVENTION

The invention relates generally to wireless communication. More particularly, the invention relates to an apparatus and method for deploying a wireless mesh network with access nodes having non-line-of-sight technology, and then providing a wireless mesh network system operator with information regarding line-of-sight links between access nodes of a wireless mesh network so that the system operator can intelligently upgrade the access nodes that have line-of-sight links.

### BACKGROUND OF THE INVENTION

FIG. 1 shows a wireless mesh network. The network includes wireless access nodes 130, 140, 150, 160, 170 that provide data paths between clients 180, 190 and gateways 110, 120. The gateways 110, 120 are connected to a wired network 105 which can be connected to the internet 100.

Wireless mesh networks can be quickly and inexpensively deployed because they do not require as much infrastructure as wired networks. However, wireless networks include wireless links that are typically subject to environmental conditions that influence performance of the wireless links of the mesh network. The environmental conditions include signal interference, transmission signal attenuation and transmission signal multi-path propagation. Typically, the environmental conditions vary over time.

Routing selections can be made between the gateways 110, 120 and the access nodes 130, 140, 150, 160, 170. The routing selections are typically made to provide the most reliable connections between the access nodes 130, 140, 150, 160, 170 and the gateways 110, 120. The most reliable link between two access nodes is typically a line-of-sight link. However, conditions typically exist in wireless mesh networks in which adjacent wireless access nodes do not have line-of-sight links. For example, obstacles such as obstacles 115, 116 shown in FIG. 1, prevent line-of-sight links from existing between access nodes 130 and 160, and access nodes 120 and 140. Non-line-of-sight links typically are lower quality links than line-of-sight links.

Due to the high likelihood of obstacles, successful deployment of wireless mesh networks generally requires link technology that is operational with non-line-of-sight links. However, other types of technologies that require line-of-sight can operate at high transmission capacities. Therefore, it can be desirable to replace non-line-of-sight technology links with line-of-sight technology links when the links actually have line-of-sight, reserving resources (such as, limited frequency spectrum) for non-line-of-sight links.

It is desirable to have a method of deploying access nodes of a wireless mesh network that provides the ease of deployment provided by access nodes having non-line-of-sight technology links, but can also provide the capacity of access nodes having line-of-sight technology links.

### SUMMARY OF THE INVENTION

A method and apparatus for deploying a wireless mesh network, and determining line-of-sight links between nodes of a wireless mesh network is disclosed. The line-of-sight links are communicated to a network manager, providing the network manager with the ability to upgrade the line-of-sight links, providing an increase mesh network capacity.

An embodiment of the invention includes a method of deploying of access nodes of a wireless mesh network. The method includes deploying the wireless mesh network with access nodes having non-line-of sight technology links, identifying which of the links of the wireless mesh network are line-of-sight links, and communicating the line-of-sight links to a system operator. The system operator can selectively replace non-line-of-sight technology links with higher capacity line-of-sight links, thereby increasing capacity of the wireless mesh network.

Another embodiment of the invention includes a method of determining which links of a mesh network can be upgrade to a higher capacity link. The method includes identifying links between access nodes of the mesh network, determining which of the links are line-of-sight links, and providing a network manager with information regarding the line-of-sight links.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 shows a prior art wireless mesh network.

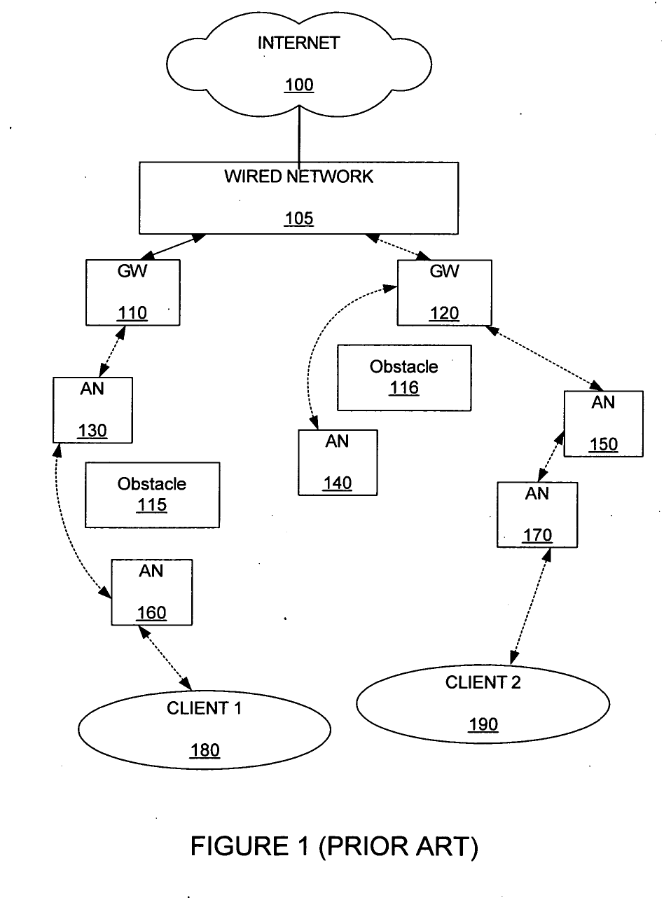

FIG. 2 shows a wireless mesh network in which line-of-sight links within the wireless mesh network have been identified.

FIG. 3 is a flow chart that includes steps of an exemplary method of deploying and selectively upgrading access nodes within a wireless mesh network.

FIG. 4 is a flow chart that includes steps of an exemplary method of providing line-of-sight information to a wireless mesh network system operator.

FIG. 5 is a mesh network that shows selection of routing paths through the mesh network.

FIG. 6 is a flow chart showing a method of selecting routing through access nodes that include both line-of-sight and non-line-of-sight technology links.

### DETAILED DESCRIPTION

The invention includes an apparatus and method of deploying a wireless mesh network, and providing a wireless mesh network system operator with link line-of-sight information, allowing the system operator to upgrade selected access nodes within the mesh network. The upgraded access nodes include higher capacity line-of-sight links enabling the mesh network to operate at a greater capacity. After being upgraded by the system operator, the access nodes of the wireless mesh network include both non-line of sight technology links (such as links operating in the 900 MHz or 2.4 GHz bands, such as 802.11(b or g)) and line-of-sight technology links (such as links operating at 5 GHz or higher, such as 802.11(a)). The access nodes within the wireless mesh network select paths to gateways of the wireless mesh network based upon link qualities, and link technologies.

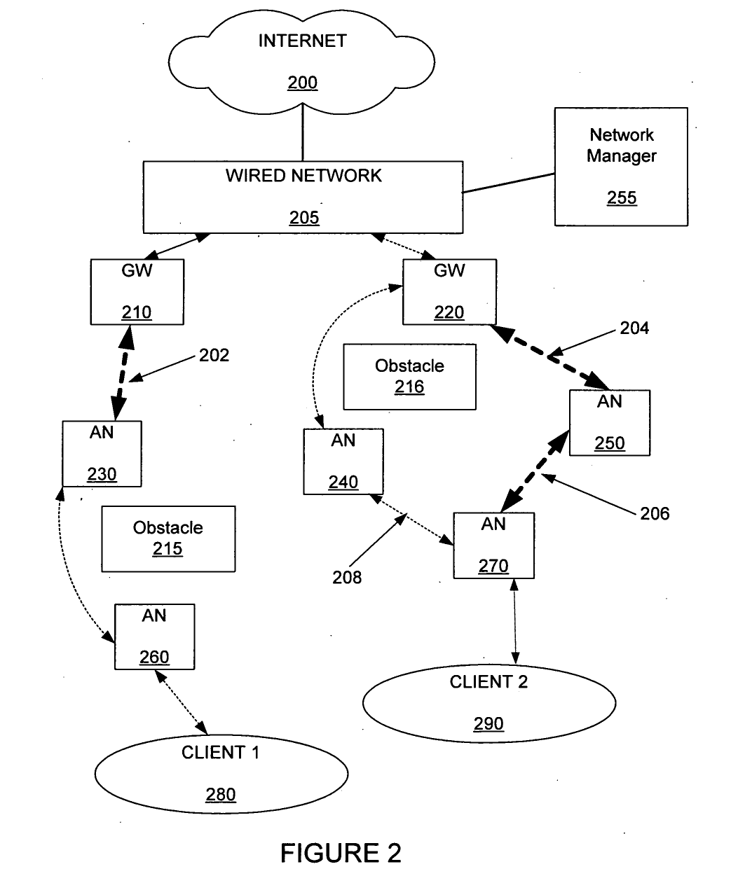

FIG. 2 shows a wireless mesh network that can benefit from a method of identifying line-of-sight links, and upgrading access nodes that are associated with the line-of-sight links. Wireless mesh networks can be deployed with minimal planning by using non-line-of-sight technology links such as 802.11b/g links. That is, the restrictions and requirements of the placement of access nodes within the mesh network are looser without line-of-sight restrictions on the links between the access nodes. However, once deployed, restricting all links to be implemented with non-line-of-sight links restricts and limits the capacity of the mesh network as a whole.

Higher capacity links as provided by line-of-sight technology links, such as 802.11a, can increase the capacity of the wireless mesh network. However, line-of-sight technology links obviously require a line-of-sight link to properly operate. Wireless mesh network that are deployed using non-line-of-sight technology links can be improved by replacing line-of-sight links with line-of-sight link technology.

The wireless mesh network of FIG. 2 includes gateways 210, 220 which can be wirelessly connected to first level access nodes 230, 240, 250. First level access nodes can be defined as access nodes located one wireless hop away from a gateway. The first level access nodes 230, 240, 250 can be wirelessly connected to second level access nodes (access nodes that are two wireless hops away from a gateway) 260, 270. A first client 280 and a second client 290 can connect to the internet 200 through the wired network 205, the gateways 210, 220 and the access nodes 230-270.

As shown, obstacles 215, 216 can prevent the access nodes from having line-of-sight links. The obstacles can be any object (for example, buildings, trees, mountains, hills, billboards) that prevents proximate access nodes from having a direct line of sight. Without a direct line-of-sight between access nodes, transmission paths between the access nodes follow non-direct paths, or must penetrate the objects. Non-direct transmission paths include one or more reflections of the transmission signals off of objects located in the non-direct path between communicating access nodes. Typically, wireless communication between access nodes coupled by non-direct transmission paths suffer from attenuation, multi-path and fading. Multi-path and fading can greatly degrade the quality of the transmission signals. Therefore, the technology used to implement non-line-of-sight links must be robust. These are typically lower frequency links that can follow non-direct transmission paths, or penetrate obstacles. Additionally, the low frequency links are typically are typically scarce because many links are competing for the allocated frequency spectrum. However, the characteristics of the links that make them robust can also cause the capacity of the links to suffer.

A method of improving the capacity of a non-line-of-sight technology implemented wireless mesh networks is to selectively replace line-of-sight links with line-of-sight technology links. The line-of-sight technology links typically will not properly transmit over non-line-of-sight links, but the line-of-sight links have greater transmission capacity than the non-line-of-sight technology links when transmitting over line-of-sight links.

After deployment of the mesh network, line-of-sight links can be identified. For example, line-of-sight links 202, 204, 206, 208 of FIG. 2 can be identified as line-of-sight links, and upgraded with line-of-sight link technology. More specifically, the gateways 210, 220 and access nodes 230, 240, 250, 270 associated with the line-of-sight links can be upgraded to support the line-of-sight technology links. An exemplary implementation includes deployment of the mesh network with access nodes having 802.11(b/g) links, and upgrading the links of the access nodes and gateways with 802.11(a) links where line-of-sight links have been identified. For example, the mesh network of FIG. 2 can be deployed with gateways 210, 220 and access nodes 230-270 supporting 802.11(b/g) links. Once the line-of-sight links 202, 204, 206, 208 have been identified, the gateways 210, 220 and access nodes 230, 240, 250, 270 that support these links can be upgraded to support 802.11(a) links. The resulting wireless mesh network configuration provides greater capacity than the network would without the upgrade. 802.11(b/g) and 802.11(a) are provided as examples of non-line-of-sight and line-of-sight links. However, it is to be understood that other types of non-line-of-sight and line-of-sight links exist.

Very little planning is required when deploying the mesh network with non-line-of-sight technology links. Upgrading line-of-sight links with line-of-sight technology links improves the capacity of the mesh network. Identify line-of-sight links before deployment can be difficult. Deploying with only line-of-sight technology links is also difficult.

Identifying Line-of-Sight Links

An exemplary method of determining whether a link is a line-of-sight link includes measuring transmission signal attenuation, and comparing the resulting attenuation with and expected line-of-sight transmission attenuation.

As described, the initial deployment of the wireless mesh network includes access nodes that have non-line-of-sight technology links. For example, the initial deployment can include access nodes that include 802.11(b/g) links having a transmission frequency of 2.4 GHz. The transmission signal attenuation for each link can be determined by measuring the received signal strength of the 2.4 GHz 802.11(b/g) signals, and comparing the measured signal received signal strength with the expected received signal strength.

The expected received signal strength can be determined by knowing the distances between the access nodes. The distances can be determined by knowing the locations of the access node. The locations of the access nodes can be determined by a system operator recording the locations at the time of deployment. The locations can alternatively be determined by including GPS (global positioning system) circuits within each access node. Once the locations of the access nodes have been determined, the expected signal attenuation, and therefore, the expected received signal strength can be determined.

The measured received signal strength can be compared with the expected received signal strength to determine whether the corresponding link is a line-of-sight link. If the measured received signal strength is within a small margin of the expected line-of-sight received signal strength, then the link can be predicted to be unobstructed, or have only minor obstructions.

Other method can be used for determining whether a link is a line-of-sight link or not. For example, line-of-sight links can be identified by comparing a signal delay spread of a corresponding received signal with an expected line-of-sight signal delay spread. The delay spread of signals received over line-of-sight links it very different than the delay spread of signals received over non-line-of-sight links. Another method includes measuring the transmission time of the transmission signals, and comparing the measured time with an expected line-of-sight transmission time. The expected line-of-sight transmission time can be determined by knowing the locations, and therefore, the distance between transmitting and receiving access nodes.

The links between every access node within the wireless mesh network can be characterized for line-of-sight determination. A list of candidate links for upgrading can be created, and provided to a system operator. The operator can then upgrade the corresponding access nodes with the line-of-sight technology links (for example, 802.11(a) operating at 5.8 GHz).

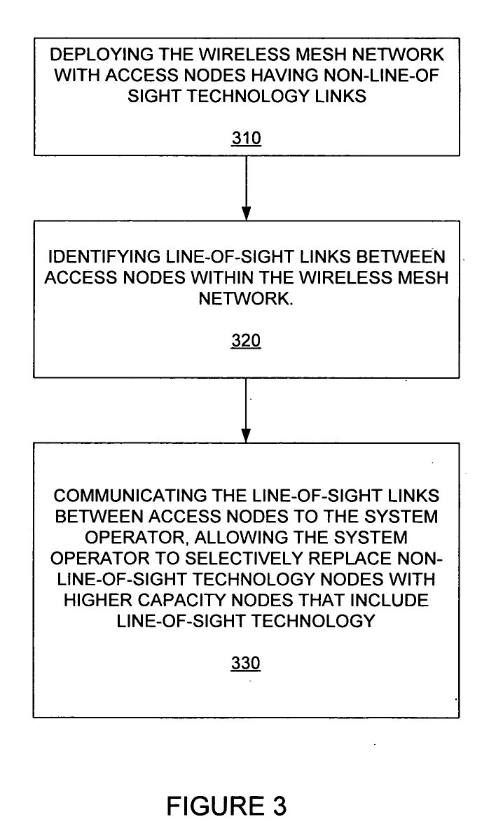

FIG. 3 is a flow chart that includes steps of an exemplary method of deploying a wireless mesh network with non-line-of-sight technology access node, and allowing a wireless mesh network system operator to improve capacity of the wireless mesh network by selectively upgrading the access nodes. A first step 310 includes deploying the wireless mesh network with access nodes having non-line-of sight technology links. A second step 320 includes identifying line-of-sight links between access nodes within the wireless mesh network. A third step 330 includes communicating the line-of-sight links between access nodes to the system operator, allowing the system operator to selectively replace non-line-of-sight technology nodes with higher capacity nodes that include line-of-sight technology.

As previously described, deploying wireless mesh network is substantially simpler with non-line-of-sight technology links. The access nodes can, for example, be placed on streetlights without having to ensure that links between the access nodes are line-of-sight links. The mesh network can then be upgraded by identifying the line-of-sight links that result when the mesh network is deployed. Rather than forcing a system operator to visually inspect the mesh network to determined line-of-sight links, the mesh network can automatically identify the line-of-sight links, and then communicate the line-of-sight links to the system operator. The system operator can upgrade access nodes that are associated with the line-of-sight links with line-of-sight technology links, increasing the capacity of the mesh network. As will be described, the upgraded mesh network can select routing paths through the mesh network based on link qualities, and the type of technology (line-of-sight or non-line-of-sight) used to implement the links.

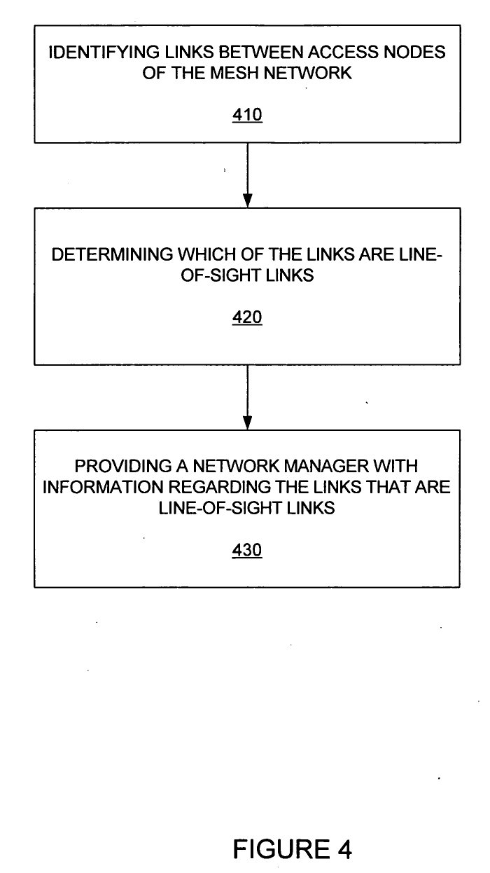

FIG. 4 is a flow chart that includes steps of an exemplary method of providing line-of-sight information to a wireless mesh network system operator. This method may be more applicable to improving an existing wireless mesh network. A first step 410 includes identifying links between access nodes of the mesh network. A second step 420 includes determining which of the links are line-of-sight links. A third step 430 includes providing a network manager with information regarding the links that are line-of-sight links.

Communicating the Line-of-Sight Links to the System Operator

FIG. 2 includes an exemplary network manager 255 connected, for example, to the wired network 205. The network manager includes software which allows a system operator to access some information and control parameters associated with the gateways and access nodes. One information parameter includes link line-of-sight information. The line-of-sight detection can be initiated by the system operator through the network manager 255. The line-of-sight information is then conveyed to the system operator, allowing the system operator to intelligently upgrade technology links of the access node of the mesh network.

Routing Within a Mesh Network Having Line-of-Sight and Non-Line-of-Sight Links

Once having been deployed or upgraded, the wireless mesh network selects routing paths. An exemplary method of selecting routes through a mesh network includes each access node of the mesh network receiving routing beacons from at least one upstream access node or upstream gateway. The access node selects an upstream link depending upon whether the link is a line-of-sight technology link or if the link is a non-line-of-sight technology link. That is, preference is to select an upstream link that includes a line-of-sight technology link. When selecting between similar technology upstream links (line-of-sight or non-line-of-sight), a quality of received routing beacons is used to make the selection.

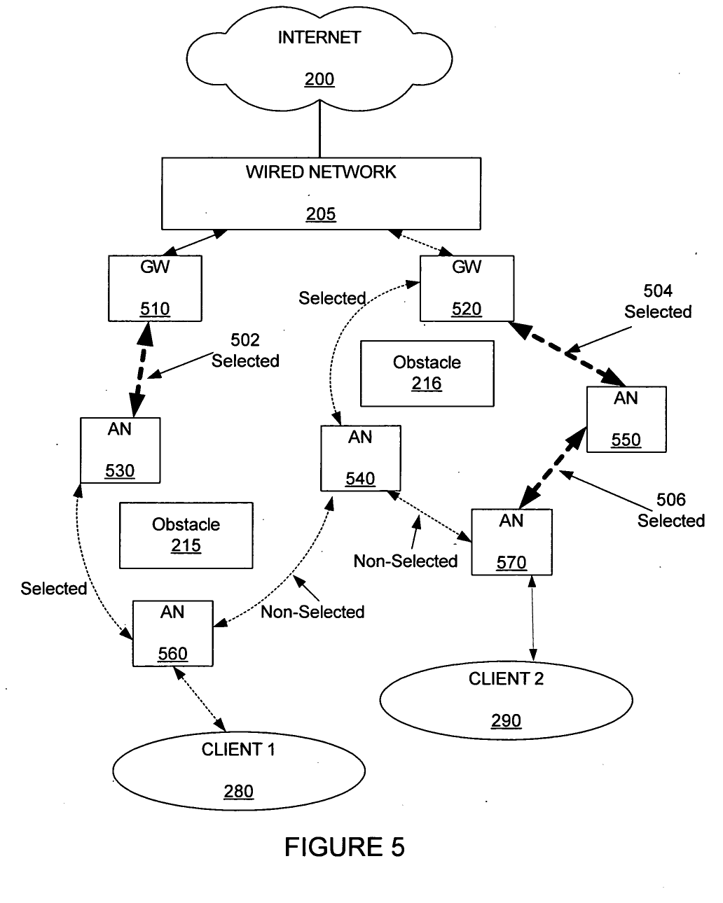

FIG. 5 is a mesh network the shows the selection of routing paths through the mesh network. Gateways 510, 520 originate routing beacons which are broadcast a predetermined number of times a second. The routing beacons are received by all first-level access nodes (such as access nodes 530, 540, 550). The beacons are used to establish a route from each access node to the gateways 510, 520. First level access nodes are defined by the fact that they receive data directly from a gateway. The first level access nodes re-broadcast the beacons, attaching their own data (such as, addresses of the access nodes) to them. This indicates to the second level access nodes that the path to the gateway includes the first level access nodes. The routing beacons are routing packets—short data packets that contains the address of the gateway.

The link technology used to implement an upstream link, and link quality of the beacons received can be used to determine whether a beacon is rebroadcast by a receiving access node. If the quality of the beacon is the best of all beacons received from upstream access nodes and gateways, it is rebroadcast. Otherwise, it is not. An exemplary embodiment of link quality is determined by persistence, i.e. the number of times in the last several routing cycles that the particular beacon was received. Typically, the link quality reflects the reliability of a path to the gateway. The link quality can be determined by continuously monitoring the beacons as they are received in every cycle. Whenever the beacon is not received in a cycle, the link quality associated with that path is decreased. The beacon is only rebroadcast if its link quality is the best of all beacons received from upstream access nodes.

After a routing beacon has been received by every access node, every access node has the address of an upstream access node, which leads to the gateway. For one embodiment, each access node also has a path to the gateway. A reverse beacon is then sent out through the access nodes, up to the gateway. The reverse beacon permits the gateway to establish a full access node tree, enabling the gateway to access all access nodes. Furthermore, the reverse beacon informs each access node what downstream nodes access the gateway through the access node.

Each access node has at least one upstream node, and may have a plurality of downstream nodes. Upstream nodes are the nodes that are between the access node and the gateway. Upstream links are links in a path to a gateway. Downstream links are in a direction away from a gateway. For a level one access node, there is only one upstream node, the gateway. For a level four access node, there are four upstream nodes, which define the access node's path to the gateway. Downstream nodes are nodes that receive the beacon from a particular access node, and define their path to a gateway through that access node.

Routing beacons broadcast by level one access nodes are received by access nodes that are two hops from the gateway (level two access nodes) 560, 570. It may happen that a level two access nodes 560, 570 receives beacon rebroadcast from two or more level one access nodes. In this case, the level two access node selects one of the two proffered routes, and rejects the other(s). As previously stated, line-of-sight links are preferred. If a level two access node receives beacons over multiple similar technology links (that is, multiple line-of-sight links, or multiple non-line-of-sight links), the level two access node selects the upstream link providing beacons of the best link quality. That is, if the level two access node receives routing beacons over two line-of-sight links, or from two non-line-of-sight links, the access node selects the line-of-sight link or non-line-of-sight link providing beacons of the best link quality. As described above, the link quality, for one embodiment, includes the persistence of the routing beacons. For other embodiments, the link quality may further include other link quality factors.

FIG. 5 shows selected links within the mesh network. The line-of-sight links 502, 504, 506 are given selection preference over non-line-of-sight links. Non-line-of-sight links are selected if they are determined to be the best non-line-of-sight link available.

Although only a limited number of gateways 510, 520 and access nodes 530, 540, 550, 560, 570 are shown in FIG. 5, it should be understood by one skilled in the art that an almost unlimited numbers of access nodes, at almost unlimited number of hops from the gateways may be implemented.

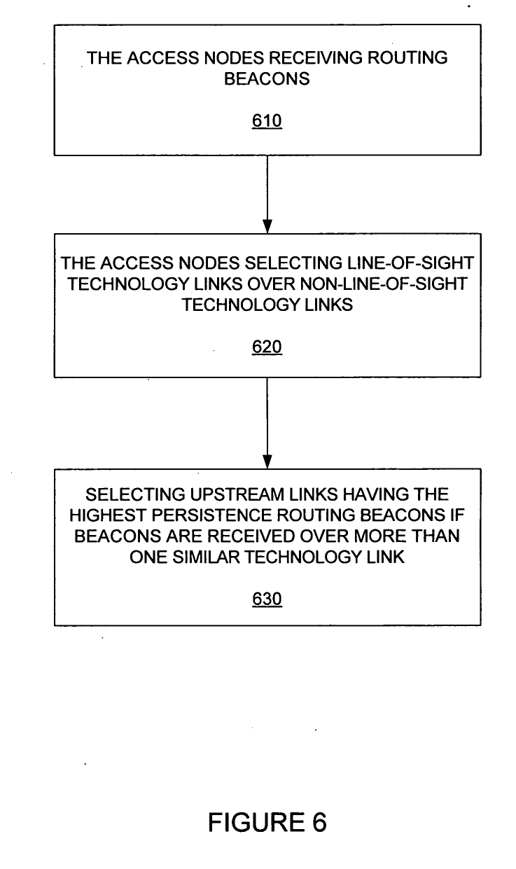

FIG. 6 is a flow chart showing a method of selecting routing through access nodes that include both line-of-sight and non-line-of-sight technology links. A first step 610 includes the access nodes receiving routing beacons. A second step 620 includes the access nodes selecting line-of-sight technology links over non-line-of-sight technology links. A third step 630 includes selecting upstream links having the highest persistence routing beacons if beacons are received over more than one similar technology link.

As stated, there is generally a preference for line-of-sight links. However, the preference, or handicap given to a line-of-sight link can be adapted or updated depending upon available capacity of either the line-of-sight or non-line-of sight links. That is, if the available capacity of a line-of-sight link is limited, the handicap or preference for that line-of-sight link may be decreased. Conversely, if the available capacity of a non-line-of-sight link is great, then non-line-of-sight link may have its preference increased.

Although specific embodiments of the invention have been described and illustrated, the invention is not to be limited to the specific forms or arrangements of parts so described and illustrated. The invention is limited only by the appended claims.

What is claimed:

1. A method of allowing a wireless mesh network system operator to improve capacity of a non-line-of-sight technology wireless mesh network, comprising:
deploying the wireless mesh network with access nodes having non-line-of sight technology links;
identifying line-of-sight links between nodes within the wireless mesh network;
communicating the line-of-sight links between nodes to the system operator, allowing the system operator to selectively replace non-line-of-sight technology nodes with higher capacity nodes that include line-of-sight technology.

2. The method of claim 1, wherein identifying line-of-sight links between nodes within the wireless mesh network comprises:
transmitting a signal over a predetermined channel from a first node to a second node;
the second node comparing a signal amplitude of a corresponding received signal with an expected line-of-sight signal amplitude.

3. The method of claim 2, wherein a link between the first node and the second node is designated a line-of-sight link if the signal amplitude of the received signal is within a predetermined margin of the expected line-of-sight signal amplitude.

4. The method of claim 2, wherein the expected line-of-sight signal amplitude is determined by determining a distance between the first node and the second node, and calculating the expected line-of-sight signal amplitude based upon the distance.

5. The method of claim 1, wherein identifying line-of-sight links between nodes within the wireless mesh network comprises:
transmitting a signal over a predetermined channel from a first node to a second node;
the second node comparing a signal delay spread of a corresponding received signal with an expected line-of-sight signal delay spread.

6. The method of claim 1, wherein identifying line-of-sight links between nodes within the wireless mesh network comprises identifying links that maintain line-of-site for a predetermined duration of time.

7. The method of claim 1, wherein identifying line-of-sight links between nodes within the wireless mesh network comprises:
identifying nodes within the mesh network that are in communication with each other;
for each of the identified nodes, transmitting a signal over a predetermined channel from a transmitting node to a receiving node;
each receiving node comparing a signal amplitude of a received signal with an expected line-of-sight signal amplitude;
designating nodes that have a received signal amplitude that is within a predetermined margin of an expected line-of-sight signal amplitude, as line-of-sight nodes.

8. The method of claim 7, wherein a list of line of sight nodes are communicated to the wireless mesh network system operator.

9. The method of claim 7, wherein identifying nodes within the mesh network that are in communication with each other comprises identifying nodes that receive routing packets from another node.

10. The method of claim 1, wherein after upgrading by the system operator, selecting routing paths through the mesh network comprises:
access nodes receiving routing beacons from upstream devices;
each access node selecting an upstream link based on whether the link is a line-of-sight links or a non-line of sight link;
when selecting between similar technology links, each access node selecting the link that provides routing beacons having a highest reception persistence.

11. The method of claim 10, wherein line-of-sight links are given routing path selection preference over non-line-of-sight links.

12. The method of claim 10, wherein the upstream device is at least one of a gateway and an upstream access node.

13. The method of claim 10, wherein the reception persistence is a measure of a number of successfully received routing beacons per unit of time.

14. The method of claim 10, wherein gateways originate and broadcast routing beacons, and access nodes rebroadcast modified routing beacons of selected upstream links.

15. A method of determining which links of a mesh network can be upgrade to a higher capacity link, comprising:
identifying links between access nodes of the mesh network;
determining which of the links are line-of-sight links;
providing a network manager with information regarding the links that are line-of-sight links.

16. The method of claim 15, wherein identifying links between access nodes of the mesh network comprises determining which non-line-of-sight technology links of the access nodes allow transmission of packets.

17. The method of claim 15, wherein determining which of the links are line-of-sight links comprises comparing a received signal power with an expected line-of-sight signal power.

18. The method of claim 17 wherein the expected line-of-sight signal power is determined by knowing distances between the access nodes.

19. The method of claim 15, wherein determining which of the links are line-of-sight links comprises:
for each of the identified links, transmitting a signal over a predetermined channel from a transmitting node to a receiving node;
each receiving node comparing a signal amplitude of a received signal with an expected line-of-sight signal amplitude;
designating nodes that have a received signal amplitude that is within a predetermined margin of an expected line-of-sight signal amplitude, as line-of-sight nodes.

20. A wireless mesh network comprising:
means for identifying nodes within the mesh network that are in communication with each other;
means for transmitting a signal over a predetermined channel from a transmitting node to a receiving node for each of the identified nodes;
means for comparing a signal amplitude of a received signal with an expected line-of-sight signal amplitude for each receiving node;
means for designating nodes that have a received signal amplitude that is within a predetermined margin of an expected line-of-sight signal amplitude, as line-of-sight nodes;
means for communicating the line-of-sight links to a network manager.
